(19) United States
(12) Patent Application Publication
(10) Pub. No.: US 2015/0321128 A1
(43) Pub. Date: Nov. 12, 2015

(54) Residential Laundry Water Recycling and Irrigation System

(71) Applicant: Michael Gross, Tucson, AZ (US)

(72) Inventor: Michael Gross, Tucson, AZ (US)

(21) Appl. No.: 14/120,233

(22) Filed: May 9, 2014

(51) Int. Cl. B01D 35/147

(52) U.S. Cl. CPC B01D 35/147

(57) ABSTRACT

A water retention and disbursement mechanism used for recycling grey water. A housing is used to contain a reservoir which receives water from a grey water source such as a water basin or laundry machine via an inlet port. An overflow opening allows for the discharge of excess water from the reservoir into a sewer system. A pump, ideally contained within the reservoir, is activated by a float mechanism allowing the pump to withdraw from the reservoir and be discharged directly to a landscape irrigation system such as dripper, spray nozzles, or the like.

### BACKGROUND OF THE INVENTION

This invention relates generally to water recycling and more specifically to a contained unit for the collection and disbursement of laundry water for irrigation purposes.

The resource of water is becoming more and more limited as well as becoming much more expensive to acquire, filter, and treat for human exposure. Within the industrial world though, “grey water”, water which is not contaminated with human waste, is subjected to the same sewage treatment as “black water”. Community Sewage plants must therefore be designed to handle both black and grey water while the vast amount of the volume is from grey water sources (e.g. bathing, washing, laundry).

Municipalities are not the only entities which have increased costs for grey water treatment. Residential households must purchase purified/treated water suitable for drinking for applications which do not require this stringent level of sanitized water. Gardening, vegetable patches, and lawns are prime examples of applications where grey water should be recycled, thereby reducing the use of sanitized drinking water.

While this fact has been recognized, the practical hurdle facing reclamation of grey water has been the infrastructure required. Although industrial situations are able to absorb the costs to retro-fit a site or to design reclamation into the original plans for a site, residential users cannot justify the high infrastructure costs required by many of the accepted techniques. Because of this, residential reclamation of grey water has remained minimal.

Another hurdle in residential reclamation systems is that it must be as user friendly as possible. A home owner cannot and will not spend a significant amount of personal time in operating any reclamation system.

Should residential reclamation become economically feasible, municipal water systems would also benefit. The volume of waste water that they must treat would be reduced significantly, the volume of fresh water that would need to be purified would be reduced, and the overall infrastructure for both process would be reduced. Further, water delivery and water removal capitalization would be reduced.

Environmentally, residential reclamation of grey water would also be beneficial as the “drain” on aquifers would be reduced as well.

It is clear that there is a significant need for an automatic water recycling system which provides easy installation.

### SUMMARY OF THE INVENTION

The invention provides an easy to use residential water reclamation mechanism that is easily retro-fitted into existing homes; thereby providing economical water usage by recycling grey water.

Those of ordinary skill in the art readily recognize a variety of mechanisms which are used in the reclamation technology. Some, but not all, of these are described in U.S. Pat. No. 8,623,200, entitled “Grey Water Filtering System” issued Jan. 7, 2014, to Williamson, incorporated hereinto by reference.

Ideally, the unit is contained within a single housing, allowing the reclamation system to be placed within the residence and then plumbed appropriately to recover the greay water and deliver the collected grey water into an irrigation system. The housing may take on a variety of structures to meet the market sought.

Within the housing is a reservoir which is plumbed to receive water. Although the ideal source of this grey water is a residential laundry unit, any source of grey water is acceptable in this context. Another example of a grey water source is a water basin/sink.

An overflow opening in the reservoir permits the discharge of excess water into am existing sewer or septic system. This overflow discharge assures that the reservoir never becomes completely full should there be a malfunction of the mechanism.

A pump withdraws the water from the reservoir and discharges the water directly into a landscape or irrigation system. This direct discharge of the water eliminates any need for a pressure system allowing the entire mechanism to operate without undue mechanical stress and with reduced capital expense.

Ideally the pump is contained within the reservoir although in some embodiments the pump is not within the housing unit but exterior to the reservoir to facilitate easy access for maintenance. If the pump is contained within the reservoir, it is ideally positioned proximate to the bottom of the reservoir and is a submersible type of pump.

The irrigation system is one of many well known in the art, including, but not limited to: drippers, spray nozzles, and flood systems.

The pump is activated by a float mechanism which senses the depth of the water within the reservoir. Those of ordinary skill in the art readily recognize a variety of such systems.

In the preferred embodiment, there are two filters used to strain the grey water prior to the irrigation system. The primary filter is positioned to treat water from the grey water source. This primary filter is used to extract the larger elements which might be contained within the grey water so that this debris does not hamper operation of the pump nor foul the system.

The secondary filter is positioned to treat water being discharged from the pump. The secondary filter removes even finer debris.

In the preferred embodiment, the first/primary filter and the second/secondary filter are contained within the housing unit, although some embodiments utilize in line filters which are external to the housing.

In the preferred embodiment, the primary filter is contained within a filter housing. A reverse water flow is selectively activated by the user to dislodge debris from the filter and flow into the sewer/septic system.

A variety of embodiments are possible for the present invention. By choosing a housing unit structure, the water retention and disbursement mechanism of this invention is able to address different market needs. In one such embodiment, the housing unit is configured to support a laundry machine; thereby allowing a washer, such as a front loading type, to be placed onto the recycling mechanism to reduce the floor space required for the entire assembly.

Yet another embodiment of the housing employs a sink or water basin configured onto the top of the housing unit. This sink is often found in a laundry room and thereby permits the recycling of the present invention to be easily incorporated into an existing residential laundry room. In this embodiment, water from the basin also drains into the reservoir.

The invention, together with various embodiments thereof, will be more fully explained by the accompanying drawings and the following description.

### DRAWINGS IN BRIEF

FIG. 1 is a functional layout of the preferred embodiment.

FIGS. 2A and 2B are block diagrams of two embodiments of the invention.

FIGS. 3A, 3B, and 3C illustrate different locational positions available for embodiments of the invention.

### DRAWINGS IN DETAIL

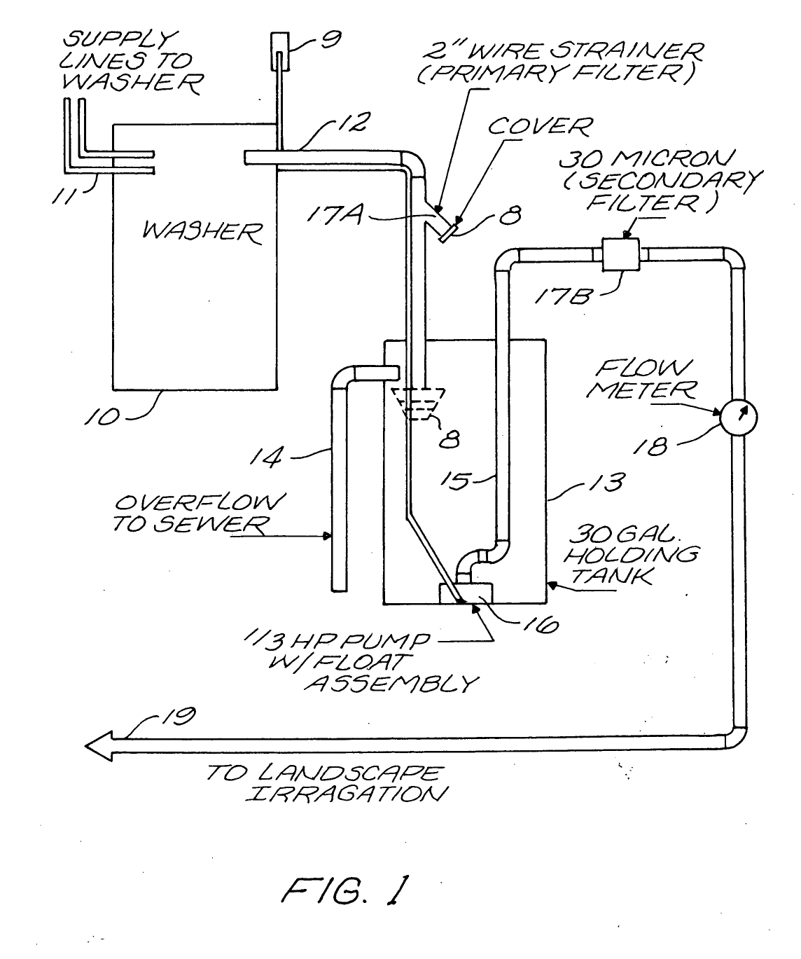

FIG. 1 is a functional layout of the preferred embodiment.

Washer 10, powered via electrical outlet 9, is provided fresh water via supply lines 11. Discharge water, grey water, is communicated via pipe 12 that passes through the primary filter 17A into reservoir 13. In this embodiment, primary filter 17A is intended to remove the larger debris from grey water flow and as such is a wire strainer which can be manually removed for cleaning via cover.

In an alternative embodiment, primary filter 17A is replaced with screen basket 8 which collects the larger debris as the grey water is discharged from pipe 12 into reservoir 13. A hatch, not shown, allows the user to remove screen basket 8 for periodic cleaning.

Another embodiment uses a reverse flow to selectively clean the primary filter 17A. Secondary filter 17B, in some embodiments, is cleaned in the same manner.

The grey water is collected within reservoir 13 for later use. Submersible pump 16 is contained proximate to the bottom of reservoir 13. Pump 16 is powered via outlet 9 and is activated by a float switch (not shown) when a predetermined level of grey water has been collected within reservoir 13.

Water from pump 16 is communicated via pipe 15 to the landscape irrigation system 19 via a secondary filter 17B. Secondary filter 17B is ideally a 30 micron filter so that any residual debris is completely removed from the grey water, thereby eliminating fouling of the irrigation system 19.

Flow meter 18 allows the user to verify the amount of grey water that has been recycled. This reading is used to establish credit from the local water supply company and/or the sewer treatment company.

Overflow 14 communicates with the existing sewer/septic system and assures that reservoir 13 does not become overwhelmed by grey water from laundry washer 10.

Washer 10 is ideally a clothes washer/laundry, although those of ordinary skill in the art readily recognize that any source of grey water may be substituted for washer 10. This includes, but is not limited to dish washers, hand sinks, bath tubs, showers, and laundry room set tubs.

In this way, the grey water is collected, filtered, and delivered to the irrigation system without the use of any pressure vessels, thereby reducing system maintenance, capital costs, and complexity.

Should the landscape irrigation system 19 have multiple zones, through the use of manually controlled or automatically controlled valves, each of the different zones is easily supplied with the filtered grey water from the system.

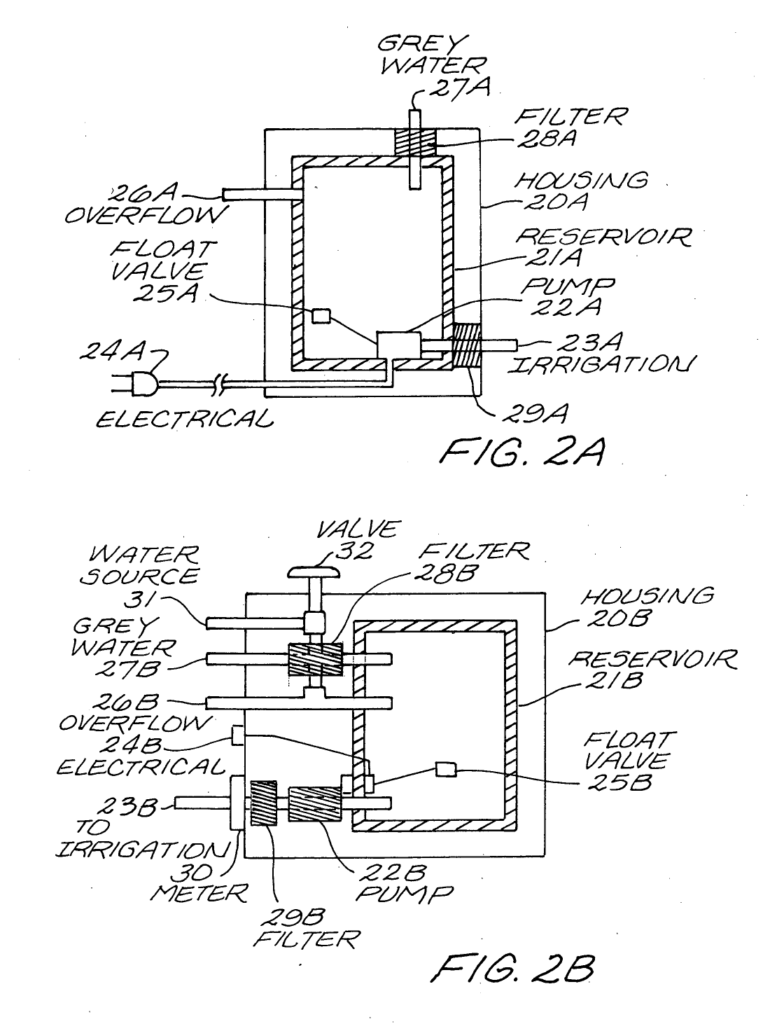

FIGS. 2A and 2B are block diagrams of two embodiments of the invention. In these two illustrations, the components for the grey water recycling mechanism are all contained within a single housing; thereby facilitating the installation of the mechanism into a residential setting. Other embodiments have various components exterior to the housing.

Referring to FIG. 2A, Housing 20A contains the entire recycling mechanism. Housing 20A is ideally made of metal although other materials are also suitable and are obvious to those of ordinary skill in the art. Reservoir 21A is contained within the housing 20A with pump 22A contained proximate to the bottom of reservoir 21A. Float valve 25A is used to activate pump 22A which is powered via electrical connector 24A.

Grey water 27A is deposited into reservoir 21A via filter 28A. Overflow 26A is connected to the existing sewer/septic tank.

Pump 22A communicates water to irrigation 23A via filter 29A.

In this manner, installation requires simple connections for: overflow 26A to the sewer/septic system, grey water 27A from the laundry or other source, and to irrigation system 23A. With the connection to electrical power 24A, the grey water system then operates automatically to recycle the grey water with minor maintenance of filters 28A and 29A.

FIG. 2B illustrates another structure where housing 20B contains reservoir 21B. Within reservoir 21B is float valve 25B which is used to activate pump 22B.

In this embodiment, pump 22B is located exterior to the reservoir and delivers the grey water directly to irrigation 23B via filter 29B and meter 30. Meter 30 is used to apply credits to the owner's bill for the recycling of the grey water.

Electrical connector 24B is used to provide electricity to pump 29B via float valve 25B.

Overflow 26B communicates with the sewer/septic system (not shown).

In this embodiment, grey water 27B passes through filter 28B and into reservoir 21B. Cleaning debris from filter 28B involves manual manipulation of valve 32C which closes off filter 28B from reservoir 21B; opens communication between filter 28B and overflow 26B while closing the overflow 26B into reservoir 21B; and, at the same time forcing fresh water 31 through filter 28B to flush debris into the sewer/septic via overflow 26B. The system is returned to normal operation by manually reversing valve 32.

In this manner, the operator may periodically clean filter 28B to assure proper operation of the system.

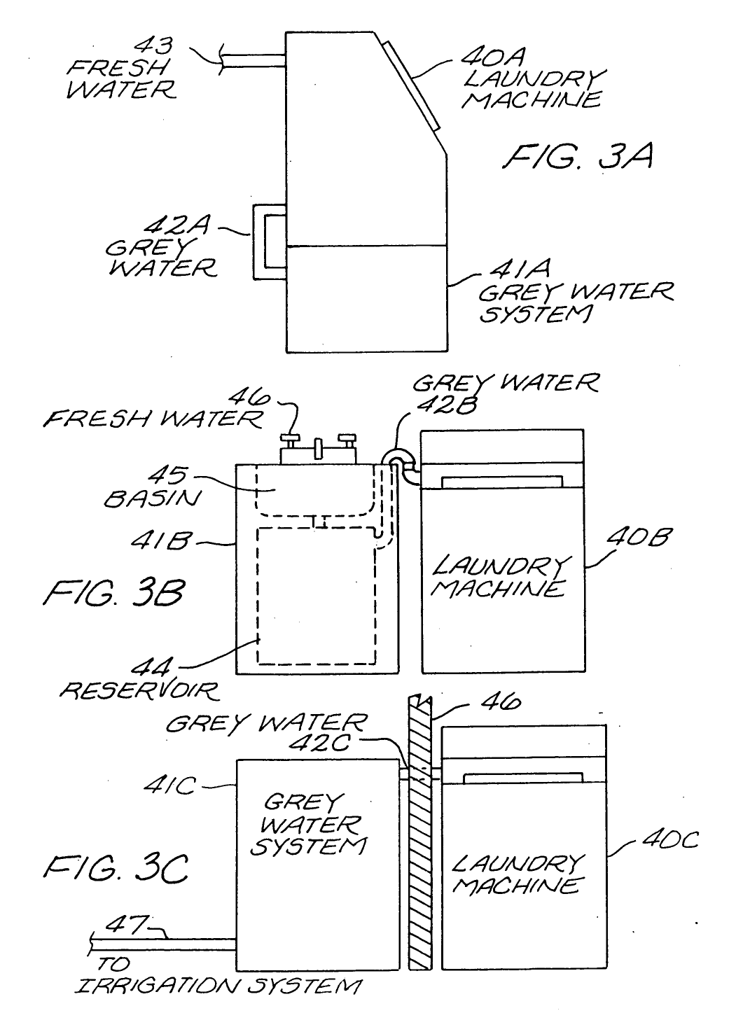

FIG. 3A, 3B, and 3C illustrate different locational positions available for embodiments of the invention.

Referring to FIG. 3A, laundry machine 40A rests on grey water system 41A. Grey water system 41A is any of those already discussed above. Laundry machine 400A receives fresh water 43 and delivers grey water 42A to the grey water system 41A for collection and disbursement to the irrigation system.

FIG. 3B places the grey water system 41B next to the laundry machine 40B. In this embodiment, the housing for the grey water system 41B includes a water basin 45 which receive fresh water via faucets 46. Water basin 45 drains into reservoir 44. Grey water 42B is also communicated from laundry machine 40B into reservoir 44.

In FIG. 3C, laundry machine 40C is located interior to the residence and communicates grey water 42C through wall 46 to the grey water system 41C. Grey was system 41C is plumbed to deliver water to irrigation system 47.

It is clear that the present invention provides for a highly improved water recycling system allowing for easy retention and disbursement of laundry water for irrigation purposes.

What is claimed is:

1. A water retention and disbursement mechanism comprising:
a) a reservoir contained within said housing, said reservoir receiving water via an inlet port from a water employing household mechanism, said reservoir having an overflow opening adapted to discharge excess water into a sewer system; and,
b) a pump being activated by a float mechanism, said pump discharging water directly to a landscape irrigation system.

2. The water retention and disbursement mechanism according to claim 1, wherein said pump is contained within said reservoir and positioned proximate to a bottom of said reservoir.

3. The water retention and disbursement mechanism according to claim 2, further including:
a) a primary filter positioned to treat water from the water employing household mechanism; and,
b) a secondary filter positioned to treat water being discharged from the pump.

4. The water retention and disbursement mechanism according to claim 3, further including a housing unit containing said reservoir and wherein the first filter and the second filter are contained within the housing unit.

5. The water retention and disbursement mechanism according to claim 3, further including:
a) a filter housing containing the first filter; and,
b) a discharge mechanism selectively disgorging debris within the first filter into the sewer system.

6. The water retention and disbursement mechanism according to claim 4, wherein the water employing household mechanism is a laundry machine

7. The water retention and disbursement mechanism according to claim 6, wherein the housing unit supports said laundry machine.

8. The water retention and disbursement mechanism according to claim 4, wherein said water employing mechanism is a water basin.

9. The water retention and disbursement mechanism according to claim 8, wherein:
a) said housing unit further includes a water basin positioned at an upper surface of said housing unit;
b) said reservoir is positioned below the water basin; and,
c) discharge water from the water basin is deposited in said reservoir.

10. The water retention and disbursement mechanism according to claim 9, wherein said reservoir further receives discharge water from a laundry machine.

11. A water recycling mechanism receiving discharge water from a laundry machine, said recycling mechanism comprising:
a) a housing unit;
b) a reservoir contained within said housing unit, said reservoir receiving discharge water from the laundry machine via an inlet port,
c) a discharge port communicating excess water from the reservoir to a sewer system;
d) a pump contained within said reservoir communicating water from the reservoir directly to a landscape irrigation system via said discharge port; and,
e) a float mechanism configured to activate said pump when a predetermined water level within said reservoir is obtained.

12. The water recycling mechanism according to claim 11, further including:
a) a primary filter positioned to treat discharge water from the laundry machine; and,
b) a secondary filter positioned to treat water discharged from the pump.

13. The water recycling mechanism according to claim 12, wherein the primary filter and the secondary filter are contained within the housing unit.

14. The water recycling mechanism according to claim 12, further including:
a) a filter housing containing the primary filter; and,
b) a discharge mechanism selectively disgorging debris within the primary filter into the sewer system.

15. The water recycling mechanism according to claim 14, wherein the housing unit supports said laundry machine.

16. A water recycling mechanism comprising:
a) a housing unit having a water basin at an upper surface thereof;
b) a reservoir contained within said housing, said reservoir receiving water from the water basin;
c) an overflow opening adapted to discharge excess water from the reservoir into a sewer system;
d) a pump contained within said reservoir, said pump discharging water directly to a landscape irrigation system; and,
e) a float mechanism adapted to activate said pump when water within said reservoir meets or exceeds a predetermined level.

17. The water recycling mechanism according to claim 15, wherein said reservoir is adapted to receive discharge water from a laundry machine.

18. The water recycling mechanism according to claim 17, further including:
a) a primary filter positioned to treat water entering said reservoir; and,
b) a secondary filter positioned to treat water being discharged from the pump.

19. The water recycling mechanism according to claim 18, wherein the primary filter and the secondary filter are contained within the housing unit.

20. The water recycling mechanism according to claim 19, further including:
a) a filter housing containing the first filter; and,
b) a discharge mechanism selectively disgorging debris within the primary filter into the sewer system.
